(19) United States
(12) Patent Application Publication
(10) Pub. No.: US 2005/0096105 A1
(43) Pub. Date: May 5, 2005

(54) Mobile phone and battery-positioning device thereof

(75) Inventor: Ulin Ju, Bangiao (TW)

Correspondence Address: QUINTERO LAW OFFICE, 1617 BROADWAY, 3RD FLOOR, SANTA MONICA, CA, 90404, US

(73) Assignee: BENQ CORPORATION, TAOYUAN (TW)

(21) Appl. No.: 10/971,323

(22) Filed: Oct. 22, 2004

(30) Foreign Application Priority Data
Oct. 29, 2003 (TW) TW92219185

(51) Int. Cl. H04M 1/00; H04B 1/38; G11B 23/02

(52) U.S. Cl. 455/575.1; 455/90.3

(57) ABSTRACT

A mobile phone and a battery-positioning device thereof. The mobile phone includes a body, a positioning device, and a battery. The positioning device is disposed on the body in a manner such that it can rotate between a first position and a second position. The battery is detachably disposed on the body. When the positioning device is located in the first position, the battery is engaged with the positioning device so that the battery is fixed on the body. When the positioning device is located in the second position, the battery is disengaged from the positioning device so that the battery is separated from the body.

### BACKGROUND OF THE INVENTION

1. Field of the Invention

The invention relates to a mobile phone and a battery-positioning device thereof; in particular, the invention relates to a mobile phone with a compact battery-positioning device.

2. Description of the Related Art

In a mobile phone, a battery is usually disposed in a receiving portion on a rear housing of a body. A release mechanism is utilized to remove the battery from the body. The release mechanism may be moved in a downward/upward direction or a frontward/rearward direction.

To enable the movement of the release mechanism, a large space is required in the mobile phone. Additionally, an opening is required to accommodate the mechanism in the exterior of the mobile phone. Furthermore, the release mechanism can simply moved in one direction.

### SUMMARY OF THE INVENTION

In order to address the disadvantages of the aforementioned mobile phone, the invention provides a mobile phone with a compact battery-positioning device to optimize element positioning inside the mobile phone.

An object of the invention is to provide a battery-positioning device capable of optimize element positioning.

Accordingly, the invention provides a mobile phone including a body, a positioning device, and a battery. The positioning device is disposed on the body in a manner such that it rotates between a first position and a second position. The battery is disposed on the body in a detachable manner. When the positioning device is located in the first position, the battery is engaged with the positioning device so that the battery is fixed on the body. When the positioning device is located in the second position, the battery is disengaged from the positioning device so that the battery is separated from the body.

In a preferred embodiment, the positioning device includes a rotating member, an elastic member and a cover. The rotating member is disposed on the body in a manner such that it rotates between the first position and the second position and moves between the first position and a third position. The elastic member is disposed on the rotating member to return the rotating member to the first position. The cover is disposed on the body to restrain the movement of the positioning device within a predetermined range. The cover may be integrally formed with the body by a thermal process.

In another preferred embodiment, the rotating member is formed with a protrusion. The battery is formed with a groove, corresponding to the protrusion, and a space communicating with the groove. When the positioning device is located in the first position, the protrusion is located in the groove so that the battery is fixed in the body. When the positioning device is located in the second position, the protrusion is located in the space so that the battery is separated from the body.

In another preferred embodiment, the body includes a first rod to limit the rotation of the protrusion within a predetermined range so that the positioning device is limited between the first position and the second position. Furthermore, the body includes a second rod abutting the elastic member in the third position, providing elastic force. The second rod is formed with a concave portion, and the cover is formed with a hook corresponding to the concave portion. The cover is connected to the body by engaging the hook with the concave portion. The cover is formed with a plurality of first holes through which the first rod and the second rod pass.

In another preferred embodiment, the rotating member is formed with an engaging portion and a supporting portion to maintain the elastic member on the rotating member. Additionally, the rotating member is formed with a rotating portion, and the body is formed with a second hole corresponding to the rotating portion. The rotating portion is exposed by the second hole.

In another preferred embodiment, the rotating member is formed with a third hole, the body includes a third rod, and the rotating member is limited between the first position and the third position by inserting the third rod into the third hole. The elastic member is formed with a fourth hole corresponding to the third hole, and the third rod passes through the fourth hole.

In the invention, a battery-positioning device for an electronic apparatus is provided. The electronic apparatus includes a body and a battery detachably disposed on the body. The battery-positioning device includes a rotating member and an elastic member. The rotating member is disposed on the body in a manner such that it rotates between a first position and a second position. When the rotating member is located in the first position, the battery is engaged with the rotating member so that the battery is fixed on the body. When the rotating member is located in the second position, the battery is disengaged from the rotating member so that the battery is separated from the body. The elastic member is disposed on the rotating member to move the rotating member to the first position.

### BRIEF DESCRIPTION OF THE DRAWINGS

The present invention can be more fully understood by reading the subsequent detailed description and examples with references made to the accompanying drawings, wherein:

FIG. 1a is a partial exploded view of a mobile phone as disclosed in the invention;

FIG. 1b is a schematic view of an assembled rotating member and elastic member of FIG. 1a;

FIG. 1c is a schematic view of the rotating member, the elastic member, and a body of FIG. 1a;

FIG. 1d is a schematic view of the assembled mobile phone in FIG. 1a;

FIG. 2a, FIG. 2c, and FIG. 2f are schematic views of assembly processes of a battery and the body;

FIG. 2b, FIG. 2e, and FIG. 2g are schematic views of the rotating member and the elastic member in FIG. 2a, FIG. 2c, and FIG. 2f;

FIG. 2d is a front view of the battery in FIG. 2a;

FIG. 3 is a schematic view of the rotating member and the elastic member during removal of the battery; and

FIG. 4 is a schematic view of another embodiment of the battery.

### DETAILED DESCRIPTION OF THE INVENTION

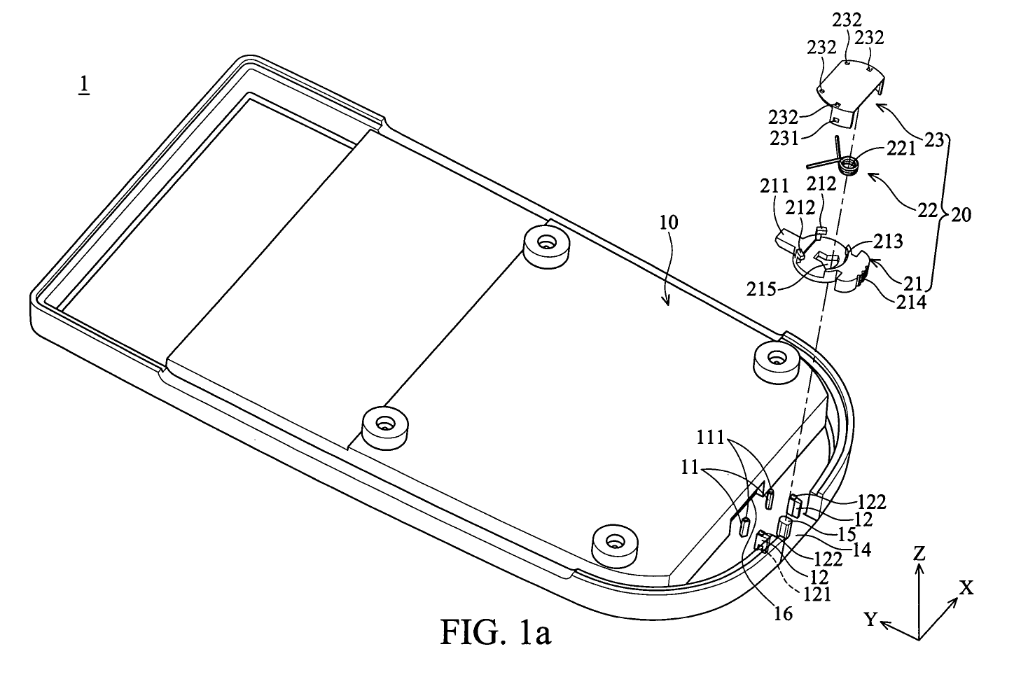

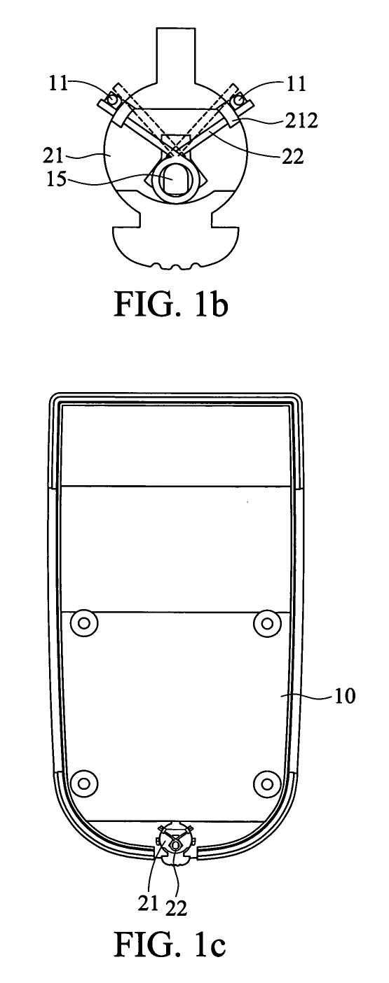

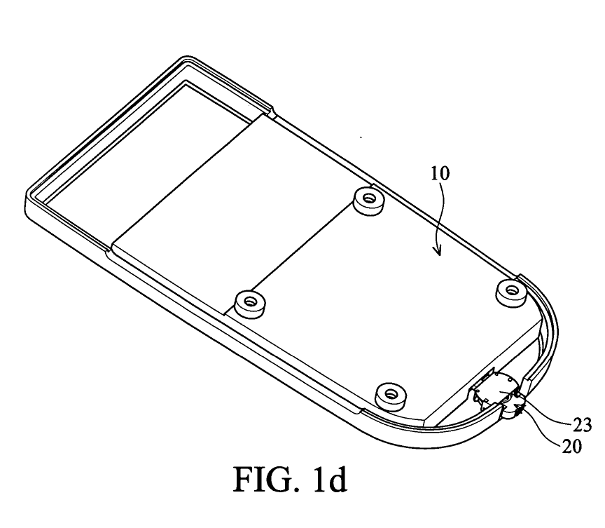

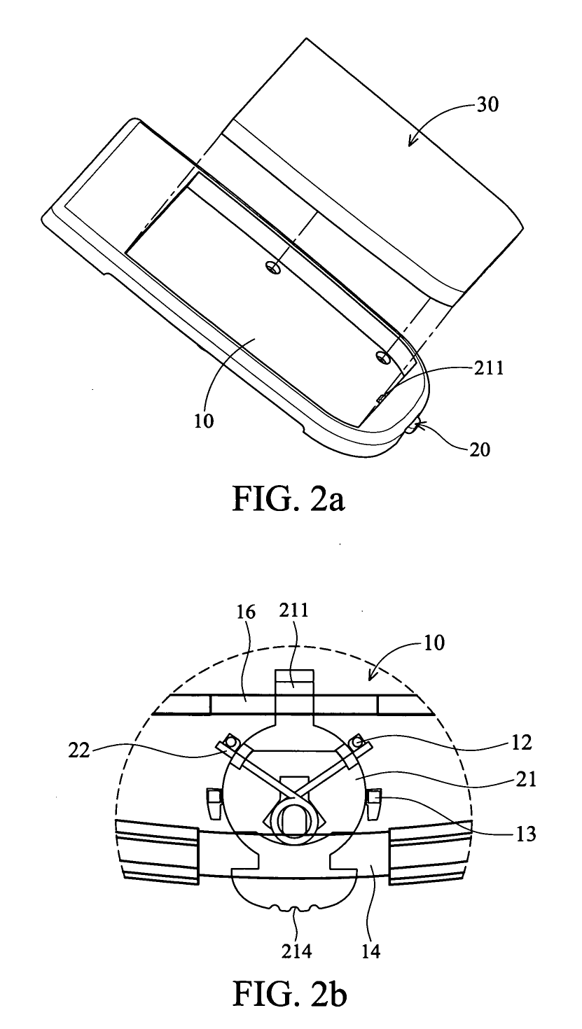

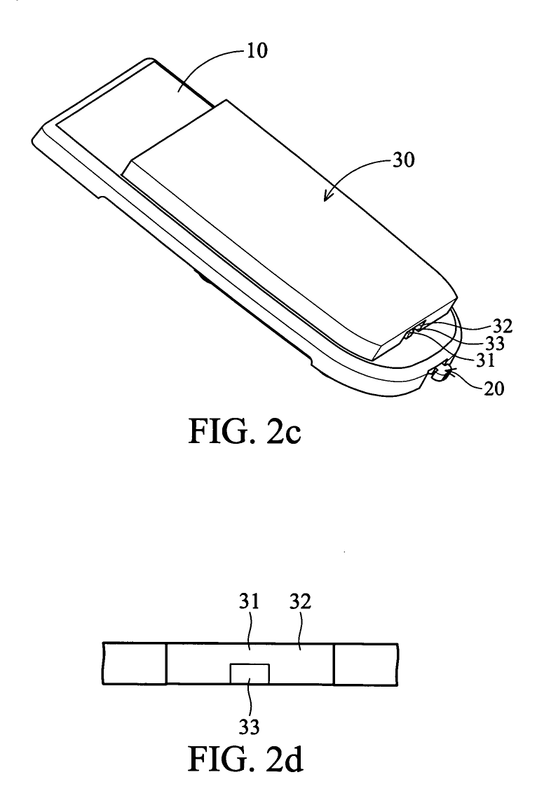

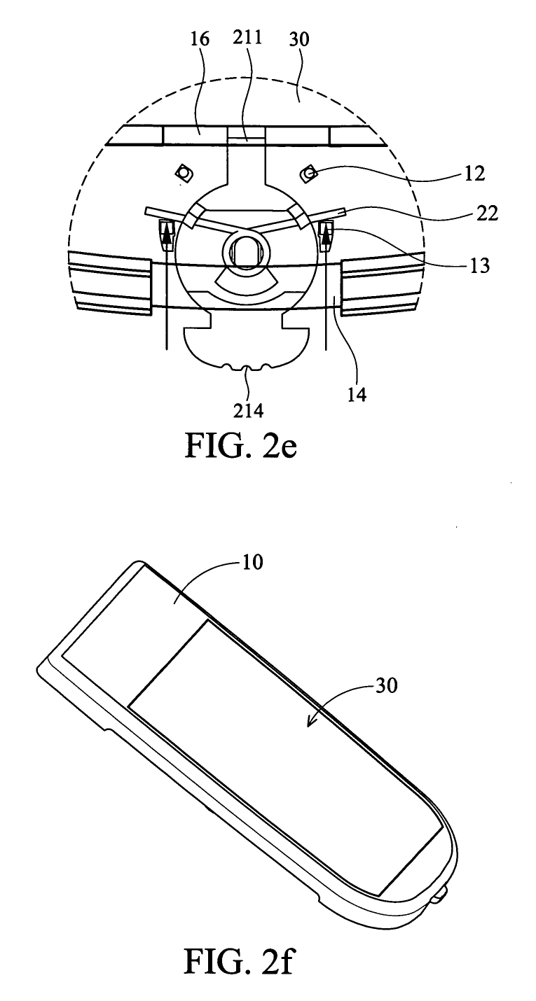

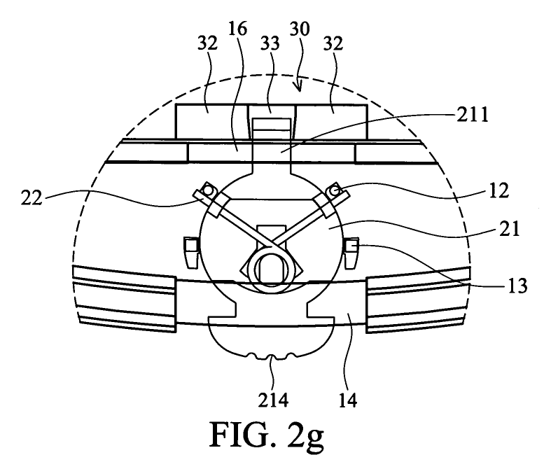

Referring to FIG. 1a and FIG. 2a, a mobile phone 1 as disclosed in the invention includes a body 10, a positioning device 20, and a battery 30. The body 10 is a basic component of the mobile phone 1, and includes basic devices required by the mobile phone 1. To clearly illustrate the positioning device 20, a housing of the body 10 is partially disassembled in FIG. 1a.

The body 10 includes two first rods 11, two second rods 12, a second hole 14, a third rod 15, and a fifth hole 16. Each first rod 11 is formed with a first block 111 at its top portion respectively. Each second rod 12 is formed with a second block 122 at its top portion, and is formed with a concave portion 121 at its sidewall respectively.

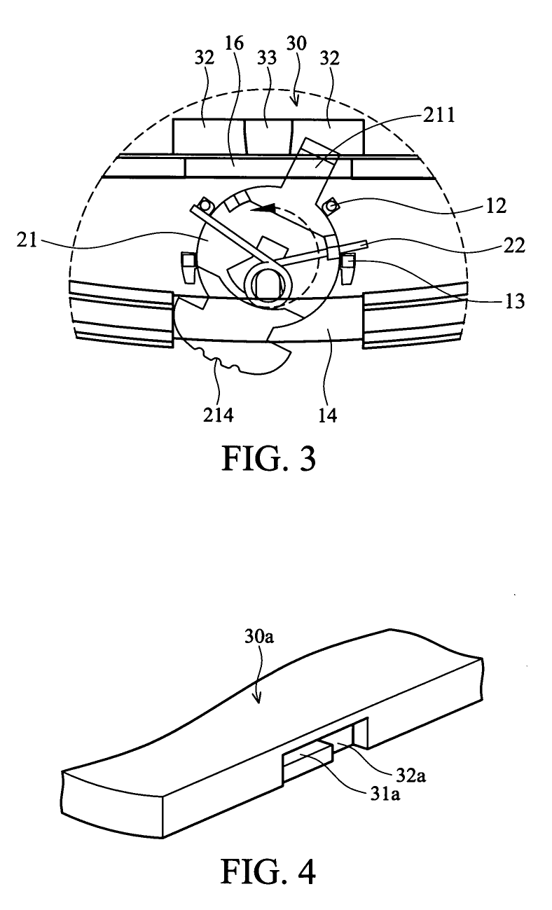

The positioning device 20 is disposed on the body 10 in a manner such that it can rotate between an idle position (shown in FIG. 2b and hereinafter referred as to a first position) and a rotated position (shown in FIG. 3 and hereinafter referred to as a second position). Additionally, the positioning device 20 can move between the first position and a compressed position (shown in FIG. 2e and hereinafter referred to as a third position).

The positioning device 20 includes a rotating member 21, an elastic member 22, and a cover 23. The rotating member 21 is disposed on the body 10, and is a basic element of the positioning device 20. The rotating member 21 is formed with a protrusion 211, two engaging portions 212, a supporting portion 213, a rotating portion 214, and a third hole 215. Rotation of the protrusion 211 is limited within a predetermined range by the first rod 11 on the body 10 as shown in FIG. 1b. That is, the positioning device 20 is limited between the first position and the second position by the first rod 11. The engaging portions 212 and the supporting portion 213 maintain the elastic member 22 on the rotating member 21. Specifically, one side of the elastic member 22 is supported by the supporting portion 213, and extension portions of the elastic member 22 are held by the engaging portions 212. Referring to FIG. 1b, the normal position of the extension portions of the elastic member 22 are shown by the dashed line. When the elastic member 22 is held by the engaging portions 212, the extension portions of the elastic member 22 are shown in solid line in FIG. 1b. Thus, the elastic member 22 can be stably disposed on the rotating member 21.

The rotating portion 214 of the rotating member 21 is exposed by the second hole 14 of the body 10. Thus, the rotating member 21 can be easily rotated. The third hole 215 of the rotating member 21 is inserted by the third rod 15 on the body 10 as shown in FIG. 1b. Thus, the movement of the rotating member 21 is limited between the first position and the third position.

As stated above, the elastic member 22 is disposed on the rotating member 21 to return the rotating member 21 to the first position. Specifically, when the positioning device 20 is located in the second position or the third position, the elastic member 22 is abutted by the second rod 12 on the body 10 so that the elastic member 22 is provided with elastic force. Furthermore, the elastic member 22 is formed with a fourth hole 221 corresponding to the third hole 215 of the rotating member 21. The third rod 15 of the body 10 passes through the fourth hole 221 and the third hole 215 as shown in FIG. 1b. Thus, the elastic member 22 can be stably disposed on the rotating member 21.

It is understood that the elastic member 22 is wound by elastic wire, and may be stainless steel or piano wire.

The cover 23 is disposed on the body 10 to limit movement of the positioning device 20 within a predetermined range in a Z-axis direction. The hooks 231 correspond to the concave portions 121 of the second rods 12 on the body 10. The cover 20 includes two hooks 231 and four first holes 232. The cover 23 is connected to the body 10 by engaging the hooks 231 with the concave portions 121 of the second rods 12. The first rods 11 and the second rods 12 of the body 10 pass through the first holes 232, thus simplifying assembly of the cover 23.

Referring to FIG. 2c, the battery 30 is detachably disposed on the body 10, and formed with a groove 31, a space 32, and a third block 33 as shown in FIG. 2d. The groove 31 corresponds to the protrusion 211 of the rotating member 21 in the positioning device 20. When the positioning device 20 is located in the first position, the protrusion 211 is located in the groove 31 so that the battery 30 is fixed in the body 10. The space 32 communicates with the groove 31. When the positioning device 20 is located in the second position, the protrusion 211 is located in the space 32 so that the battery 30 can be separated from the body 10.

To assemble the positioning device 20 on the body 10, the elastic member 22 is first assembled on the rotating member 21 as shown in FIG. 1b. The combination of the rotating member 21 and the elastic member 22 is then disposed on the body 10 as shown in FIG. 1c. The cover 23 is then disposed on the body 10 as shown in FIG. 1d. The cover 23 may be melted on the body 10.

Referring to FIG. 2a, before the battery 30 is disposed in the body 10, the positioning device 20 is located in the first position as shown in FIG. 2b. At this time, the protrusion 211 of the rotating member 21 passes through the fifth hole 16 of the body 10. The battery 30 is then in contact with the body 10 as shown in FIG. 2c. The battery 30 is also in contact with the positioning device 20 to press the protrusion 211 so that the rotating member 21 moves backward to the third position as shown in FIG. 2e. The battery 30 is then completely located in the body 10 as shown in FIG. 2f. At this time, the rotating member 21 returns to the first position by the elastic force of elastic member 22 as shown by arrows in FIG. 2e. Additionally, the protrusion 211 is located in the groove 31 of the battery 30 and is abutted by the third block 33 of the battery 30 as shown in FIG. 2g. Thus, the battery 30 can be fixed in the body 10.

The body 10 further includes an engaging device (not shown) opposite to the positioning device 20. Since the engaging device is the same as the conventional mobile phone, its description is omitted.

To remove the battery 30 from the body 10, the positioning device 20 is rotated to the second position so that the protrusion 211 is located in the space 32 and is not abutted by the third block 33 as shown in FIG. 3. Since the battery 30 is not in contact with the positioning device 20, it can be lifted by a connector (not shown) on the body 10 to be removed. When the rotating member 21 is not subjected to external force, the positioning device 20 can return to the first position by the elastic force of the elastic member 22 as shown by arrows in FIG. 3.

As shown in FIG. 3, the space 32 is formed at both sides of the groove 31. Thus, the rotating member 21 may be rotated in a clockwise or counterclockwise direction to remove the battery 30. Rotation of the rotating member 21, however, may be limited to one direction. For example, as shown in FIG. 4, the battery 30 is formed with a space 32a at one side of the groove 31a to simplify the rotation of the rotating member 21.

As stated above, the battery can be held or released by the movement and the rotation of the positioning device of the invention. Thus, a large opening in the housing of the body is not required, and the positioning of elements therein can be optimized.

While the invention has been described by way of example and in terms of the preferred embodiment, it is to be understood that the invention is not limited to the disclosed embodiment. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A mobile phone comprising:
a body;
a positioning device disposed on the body in a manner such that the positioning device rotates between a first position and a second position; and
a battery disposed on the body in a detachable manner, wherein the battery is engaged with the positioning device so that the battery is fixed on the body when the positioning device is located in the first position, and the battery is disengaged from the positioning device so that the battery is separated from the body when the positioning device is located in the second position.

2. The mobile phone as claimed in claim 1, wherein the positioning device comprises:
a rotating member disposed on the body in a manner such that the rotating member rotates between the first position and the second position and moves between the first position and a third position; and
an elastic member disposed on the rotating member to return the rotating member to the first position.

3. The mobile phone as claimed in claim 2, wherein the positioning device further comprises a cover disposed on the body to limit the positioning device to move in a predetermined range.

4. The mobile phone as claimed in claim 3, wherein the rotating member is formed with a protrusion, the battery is formed with a groove corresponding to the protrusion, and the protrusion is located in the groove so that the battery is fixed in the body when the positioning device is located in the first position.

5. The mobile phone as claimed in claim 4, wherein the battery is formed with a space communicating with the groove, and the protrusion is located in the space so that the battery is separated from the body when the positioning device is located in the second position.

6. The mobile phone as claimed in claim 4, wherein the body includes a first rod to limit the protrusion to rotate in a predetermined range so that the positioning device is limited between the first position and the second position.

7. The mobile phone as claimed in claim 6, wherein the body includes a second rod abutted by the elastic member in the third position so that the elastic member is provided with elastic force.

8. The mobile phone as claimed in claim 7, wherein the second rod is formed with a concave portion, the cover is formed with a hook corresponding to the concave portion, and the cover is engaged with the body by the hook engaging with the concave portion.

9. The mobile phone as claimed in claim 7, wherein the cover is formed with a plurality of first holes through which the first rod and the second rod pass.

10. The mobile phone as claimed in claim 2, wherein the rotating member is formed with an engaging portion and a supporting portion to maintain the elastic member on the rotating member.

11. The mobile phone as claimed in claim 2, wherein the rotating member is formed with a rotating portion, the body is formed with a second hole corresponding to the rotating portion, and the rotating portion is exposed by the second hole.

12. The mobile phone as claimed in claim 2, wherein the rotating member is formed with a third hole, the body includes a third rod, and the rotating member is restrained between the first position and the third position by inserting the third rod into the third hole.

13. The mobile phone as claimed in claim 12, wherein the elastic member is formed with a fourth hole corresponding to the third hole, and the third rod passes through the fourth hole.

14. A battery-positioning device for an electronic apparatus, wherein the electronic apparatus includes a body and a battery detachably disposed on the body, and the battery-positioning device comprises:
a rotating member disposed on the body in a manner such that the rotating member rotates between a first position and a second position, wherein the battery is engaged with the rotating member so that the battery is fixed on the body when the rotating member is located in the first position, and the battery is disengaged from the rotating member so that the battery is separated from the body when the rotating member is located in the second position; and
an elastic member disposed on the rotating member to return the rotating member to the first position.

15. The positioning device as claimed in claim 14, further comprising a cover disposed on the body to limit the positioning device to move in a predetermined range.

16. The positioning device as claimed in claim 15, wherein the rotating member is formed with a protrusion, the battery is formed with a groove corresponding to the protrusion, and the protrusion is located in the groove so that the battery is fixed in the body when the rotating member is located in the first position.

17. The positioning device as claimed in claim 16, wherein the battery is formed with a space communicating with the groove, and the protrusion is located in the space so that the battery is separated from the body when the rotating member is located in the second position.

18. The positioning device as claimed in claim 14, wherein the rotating member is formed with an engaging portion and a supporting portion to maintain the elastic member on the rotating member.

19. The positioning device as claimed in claim 14, wherein the rotating member is formed with a rotating portion exposed by the body.

20. The positioning device as claimed in claim 14, wherein each of the rotating member and the elastic member is formed with a hole.
